(19) United States
(12) Patent Application Publication
(10) Pub. No.: US 2003/0197609 A1
(43) Pub. Date: Oct. 23, 2003

(54) Detachable alarm

(76) Inventor: Hung-Chang Liu, Taipei Hsien (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/127,922

(22) Filed: Apr. 23, 2002

(51) Int. Cl. G08B 13/00

(52) U.S. Cl. 340/566; 340/693.9

(57) ABSTRACT

A detachable alarm includes an enclosure, a suction cup connected to the enclosure, a circuit board connected to the suction cup and a spring. The circuit board has a vibration sensor, and the spring presses against a surface on which the alarm is mounted. The alarm is easily detachably mounted on doors or windows by the suction cup and the enclosure. The circuit board outputs sound when the vibration sensor detect abnormal vibrations on the surface. Therefore the alarm not only conveniently stick to any place to provide security but can output sound to frighten an intruder.

### BACKGROUND OF THE INVENTION

1. Field of the Invention

The present invention relates to a detachable alarm, more specifically to an alarm easily sets up any place to warn people of abnormal conditions.

2. Description of Related Art

For house or company security, people usually install a security system in places they want to protect or hire at least one security guard to monitor the places. This kind of protection can keep the house or company safe but is very expensive. Therefore many families cannot afford to acquire security.

Families that can afford to install this type of security in a house have to install many sensors or alarms in fixed positions like doorframes, window enclosures, etc. in the house. Since the sensors or alarms cannot be moved them from the fixed positions, the sensors or alarms sense abnormal conditions in the fixed place.

Therefore, the present invention intends to provide a detachable alarm that can be easily set up any place to mitigate or obviate the aforementioned problems.

### SUMMARY OF THE INVENTION

An objective of the present invention is to provide an alarm that is easily and conveniently set any place. Therefore the alarm for security is not limited to use in a fixed place to detect abnormal conditions.

Other objectives, advantages and novel features of the invention will become more apparent from the following detailed description when taken in conjunction with the accompanying drawings.

### BRIEF DESCRIPTION OF THE DRAWINGS

FIG. 1 is a cross sectional side plan view of a first embodiment of an alarm in accordance with the present invention;

FIG. 2 is circuit diagram of the alarm in the FIG. 1;

FIG. 3 is an operational perspective view of the alarm in the FIG. 1 on the inside of a door;

FIG. 4 is a cross sectional side plan view of the first embodiment of the alarm in the FIG. 1;

FIG. 5 is a cross sectional side plan view of the first embodiment of the alarm in the FIG. 1; and

FIG. 6 is a cross sectional side plan view of a second embodiment of the alarm in accordance with the present invention.

### DETAILED DESCRIPTION OF THE PREFERRED EMBODIMENT

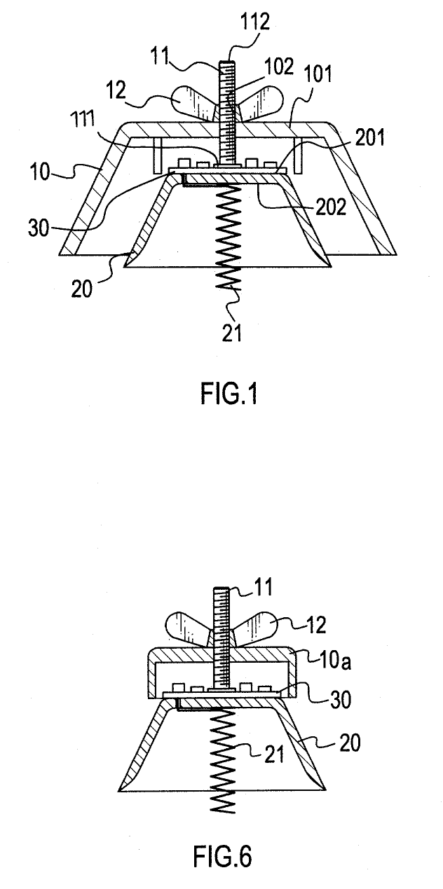

With reference to FIG. 1, a first embodiment of an alarm in accordance with the present invention comprises a cup-shaped enclosure (10), a threaded shaft (11), a nut (12), a suction cup (20), a circuit board (30), a spring (21) and a vibration sensor (not numbered). The suction cup (20) has an outer face (201) and an inner face (202).

The cup-shaped enclosure (10) has a top (101) and an opening (102) defined in the top (101) and covers the suction cup (20). The threaded shaft (11) has a first end (111) and a second end (112) and passes through the opening (102) in the enclosure (10). The first end (111) is in the enclosure (10). The second end (112) is outside of the enclosure (10). The nut (12) screws onto the threaded shaft (11) from the second end (112). The first end (111) is attached to the upper face (201) of the suction cup (20) where a though hole (not numbered) is defined. The circuit board (30) connects to the suction cup (20) and seals the through hole. A vibration sensor (not shown) is mounted on the circuit board (30), corresponds to the through hole and connects to the spring (21). One end (not numbered) of the spring (21) is attached to the inner face (202) of the suction cup (20) and passes through the through hole to connect to the vibration sensor. The other end (not numbered) of the spring (21) is free and presses against the surface on which the alarm is mounted.

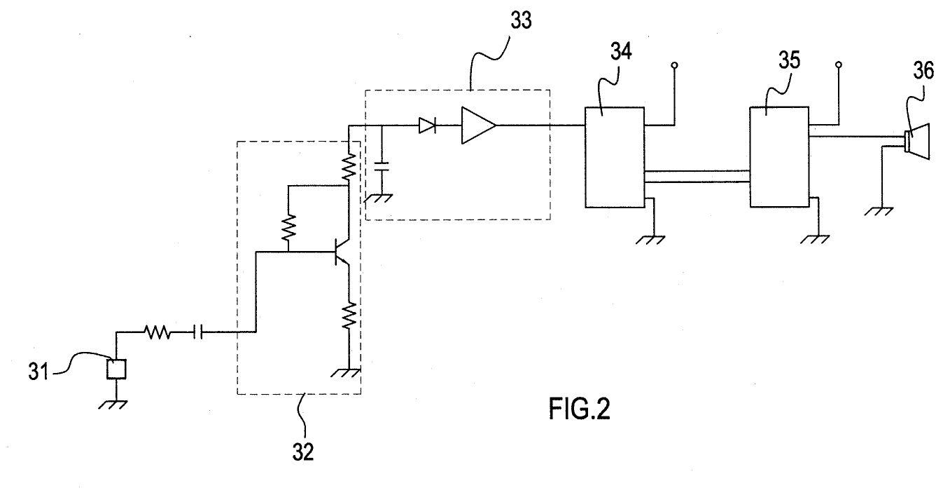

With reference to FIG. 2, the circuit board comprises the vibration sensor (31), a signal amplifier (32), an A to D converter (33), a microprocessor (34), and a voice IC (35).

The vibration sensor (31) has an output terminal connected to the signal amplifier (32) that also has an output terminal.

The A to D converter (33) connected to the output terminal of the signal amplifier (32) to convert the amplified analog signal from the signal amplifier (32) to a digital signal.

The microprocessor (34) is connected to the A to D converter (33) to obtain the digitized signal from the vibration sensor (31).

The voice IC (35) is connected to the microprocessor (34) to drive a speaker (36) to output sound when the microprocessor (34) outputs a control signal to the voice IC (35). The voice IC (35) is able to generate sounds like a dog barking or a high decibel sound to frighten thieves.

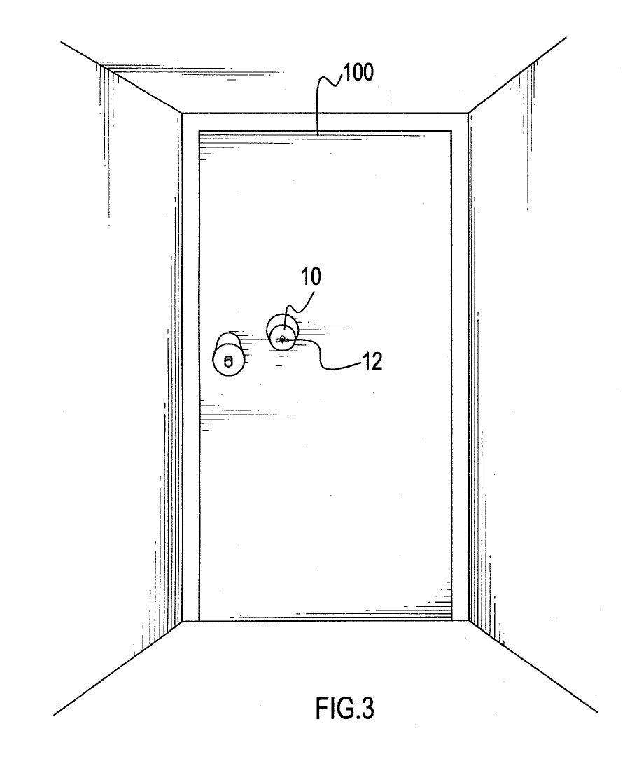

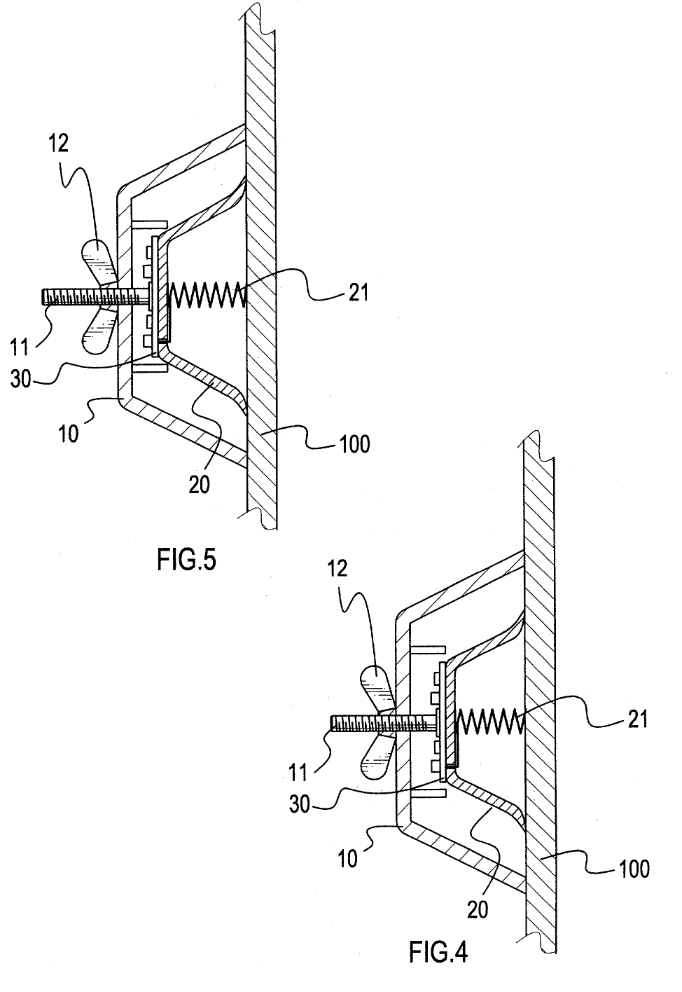

With reference to FIG. 3, the alarm is mounted on a door (100) to detect abnormal vibration on the door (100) and emit a warning or alarm. With reference to the FIG. 4, the suction cup (20) faces the door (100) when the alarm is mounted on the door (100). The suction cup (20) is pressed against the door (100) to generate a low pressure area inside the suction cup (20) and hold the suction cup (20) on the door (100). The free end of the spring (21) presses against the door (100). With reference to FIG. 5, the nut (12) is screwed onto the threaded shaft (11) to slightly pull the suction cup (20) outward to further decrease the pressure inside the suction cup (20). Therefore the suction cup (20) sticks tightly to the door (100).

With reference to FIG. 6, other embodiment of the alarm has an inverse U-shaped enclosure (10a) that is also connected to the suction cup (20).

The detachable alarm is adapted to be mounted any place with a flat surface such as the windows in car or house, so that the alarm can easily installed and moved to other places. Therefore the alarm is able to be in more places, not just in fixed positions in a house.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A detachable alarm, comprising:
an enclosure having a top and an opening defined in the top;
a suction cup having an upper face connected to an inside of the enclosure and an inner face to adapt to attach to a flat surface;
a circuit board mounted on the upper face of the suction cup wherein a vibration sensor on the circuit board connects to a spring to detect vibration of the flat surface through the spring.

2. The detachable alarm as claimed in claim 1, wherein further comprises a threaded shaft inserted into the top to connect to the upper face of the suction cup and a nut screwed onto the threaded shaft.

3. The detachable alarm as claimed in claim 2, wherein a through hole is defined in the upper face of the suction cup through which the spring passes and then connects to the vibration sensor on the circuit board.

4. The detachable alarm as claimed in claim 1, wherein the circuit board comprises
the vibration sensor having an input terminal connected to the spring and an output terminal connected to a signal amplifier;
an A to D converter connected to the signal amplifier to convert a signal from the signal amplifier to a digital signal;
a microprocessor connected to the A to D converter to receive the digital signal; and
a voice IC having a speaker connected to the microprocessor, wherein the microprocessor controls the voice IC to drive the speaker to output sound.

5. The detachable alarm as claimed in claim 2, wherein the circuit board comprises
the vibration sensor having input terminal connected to the spring and an output terminal connected to a signal amplifier;
an A to D converter connected to the signal amplifier to convert a signal from the signal amplifier to a digital signal;
a microprocessor connected to the A to D converter to receive the digital signal; and
a voice IC having a speaker connected to the microprocessor, wherein the microprocessor controls the voice IC to drive the speaker to output sound.

6. The detachable alarm as claimed in claim 3, wherein the circuit board comprises
the vibration sensor having input terminal connected to the spring and an output terminal connected to a signal amplifier;
an A to D converter connected to the signal amplifier to convert a signal from the signal amplifier to a digital signal;
a microprocessor connected to the A to D converter to receive the digital signal; and
a voice IC having a speaker connected to the microprocessor, wherein the microprocessor controls the voice IC to drive the speaker to output sound.
